(19) United States
(12) Patent Application Publication
(10) Pub. No.: US 2026/0244226 A1
(43) Pub. Date: Aug. 20, 2026

(54) SYSTEM AND APPARATUS FOR INFLUENCING TANK VACUUM, VENTING AND EMISSIONS

(71) Applicant: Chevron U.S.A. Inc., San Ramon, CA (US)

(72) Inventors: David Eric Nadel, Houston, TX (US); Christopher Ivan Day, Katy, TX (US); Louis Ralph Diamond, Houston, TX (US); Babatunde A. Oyenekan, Houston, TX (US)

(21) Appl. No.: 19/056,313

(22) Filed: Feb. 18, 2025

(51) Int. Cl. G05D 16/00; G05D 9/12

(52) U.S. Cl. CPC G05D 16/028; G05D 9/12; Y10T 137/3115; Y10T 137/3121; Y10T 137/3127; Y10T 137/313; Y10T 137/314; Y10T 137/3143; Y10T 137/3146

(57) ABSTRACT

The present embodiments describe systems and methods for controlling the pressure within a tank or container. The system can include an override controller designed to adjust the liquid levels, liquid temperatures, liquid(s) compositons and pressure levels within a tank. The override controller can receive signals from pressure, temperature, composition and liquid level readers.

### FIELD OF THE DISCLOSURE

The present disclosure relates to systems and apparatuses for monitoring and changing the volume of liquid(s) and/or vapor(s) within one or more tanks.

### BACKGROUND AND SUMMARY

The pressure inside a fixed roof tank containing oil can decrease to vacuum (less than atmospheric) after a heavy rain that starts while the roof is hot from heating by the sun. Normally, pressure vacuum relief valves (PVRV) allow air to enter the tank when the tank pressure goes below atmospheric. The limitation of this method is that air enters the tank which can lead to an unstable mixture inside the tank. Gas blanketing allows an inert or hydrocarbon gas to enter the tank at a predetermined pressure and can avoid tank vacuum conditions. The limitation of this method is the cost of the installation and usage of inert or hydrocarbon gas as well as the increased emission when the gases are eventually released to atmosphere.

Similarly, high vapor pressure fluids (vapors or liquids) that enter a tank can increase the tank internal pressure. This pressure increase may occur through a system temperature and/or volume change from external or internal heating and/or mixing of the higher vapor pressure fluids. As the vapor pressure inside the tank increases, emissions to the atmosphere result. Venting of the vapor to a vapor recovery system or external vent is a normal pathway for excess pressure. The limitation of this arrangement is that the volume of vapor is not minimized to reduce emissions and/or vapor processing rates. Control of hydrocarbon, methane, CO₂, nitrogen, greenhouse gas, toxic or chemical vapors are limited without an integrated management system.

These and other deficiencies exist. Therefore, there is a need to provide an integrated system and process that overcomes these deficiencies.

Advantageously, the systems and techniques described herein may be employed to control or reduce tank emissions including, for example, greenhouse gas or hydrocarbon emissions. The systems and techniques described may do so by changing fluid level, and/or fluid temperature, and/or fluid volume, and/or fluid flow in and/or across tanks and equipment as an integrated system.

In some aspects, the techniques described herein relate to a system for monitoring and influencing the liquid level and pressure level within a tank, the system including: a tank liquid level reader; a tank liquid level controller; a tank pressure level reader; a tank pressure controller; an override controller, wherein the override controller is configured to: receive a signal from the pressure reader, the signal including at least a reading that the pressure within the tank has reached a predetermined level; transmit to the tank level controller a command to reduce or stop the flow of liquid out of the tank via the liquid outlet(s); and/or increase or start the flow of liquid into the tank via liquid inlet(s); monitor tank levels; receive a second signal from the pressure reader, the second signal including at least a reading that the pressure within the tank has reached a safe level; transmit to the tank level controller a command to increase or resume the flow of liquid of the tank via the liquid outlet(s) and/or reduce or recycle or stop additional flow of liquid into the tank liquid inlet(s).

In some aspects, the techniques described herein relate to a method for monitoring and controlling the internal pressure level within a tank, the method including the steps of: receiving, by an override controller, a signal from a pressure reader, the signal including at least a reading that the pressure within the tank has reached a predetermined pressure; transmitting, by the override controller, a command to reduce or stop the flow of liquid out of the tank via the liquid outlet(s); and/or increase or start the flow of liquid into the tank via liquid inlet(s); monitor tank levels; receive a second signal from the pressure reader, the second signal including at least a reading that the pressure within the tank has reached a safe level; transmit to the tank level controller a command to increase or resume the flow of liquid of the tank via the liquid outlet(s) and/or reduce or recycle or stop additional flow of liquid into the tank liquid inlet(s).

In some aspects, the techniques described herein relate to an apparatus including an override controller configured to: receive one or more signals from a liquid level reader or pressure reader associated with an enclosed tank; transmit one or more commands to a liquid level controller and pressure controller to reduce or stop liquid outlet(s) and/or increase or start liquid inlet(s); monitor tank levels; receive a second signal from the pressure reader, the second signal including at least a reading that the pressure within the tank has reached a safe level; transmit to the tank level controller a command to increase or resume the flow of liquid of the tank via the liquid outlet(s) and/or stop or reduce or recycle the additional flow of liquid into the tank liquid inlet(s). Further features of the disclosed systems and methods, and the advantages offered thereby, are explained in greater detail hereinafter with reference to specific example embodiments illustrated in the accompanying drawings.

In some aspects, the techniques described herein relate to an apparatus including and override controller configured to: receive one or more signals from a liquid level reader, temperature and/or pressure reader associated with an enclosed tank; transmit one or more commands to a liquid level controller and pressure controller to reduce or stop liquid outlet(s) and/or increase or start liquid inlet(s); transmit one or more commands to a temperature controller to change liquid and/or vapor volume by changing liquid and/or vapor temperature; monitor tank levels; receive a second signal from the pressure reader, the second signal including at least a reading that the pressure within the tank has reached a safe level; transmit to the tank level controller a command to increase or resume the flow of liquid of the tank via the liquid outlet(s) and/or stop or reduce or recycle the additional flow of liquid into the tank liquid inlet(s). System operating parameters adjustments may be made depending on tank gas analyzer(s) (O_{2,} CH₄, Composition) and/or liquid analyzer(s) (Composition), Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an example system having a tank with the tank pressure control system.

FIG. 2 illustrates a method flowchart illustrating a process according to an exemplary embodiment.

FIG. 3 is a block diagram illustrating an exemplary system that may be configured to perform the method of FIG. 2.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The invention relates generally to apparatuses and systems for monitoring and changing the liquid level, temperature and/or pressure within a tank as a system. The invention uses a tank low pressure signal to override the tank liquid level controller to ultimately slow or stop net liquid outflow from the tank. This may be done by adjusting liquid flow relative to the tank in a number of ways, for example by reducing or stopping liquid flow out of the tank (e.g., via one or more outlets) and/or by increasing or starting the liquid flow into the tank (e.g., via one or more inlets). Similarly, the invention uses tank high pressure signal to override the tank liquid level and/or temperature controllers to increase net liquid and/or vapor outflow from the tank, and/or decrease net liquid and/or vapor inflow to the tank, and/or decrease the tank liquid and/or vapor temperatures to reduce tank internal pressure. Examples of some representative mechanisms for making these changes are set forth below.

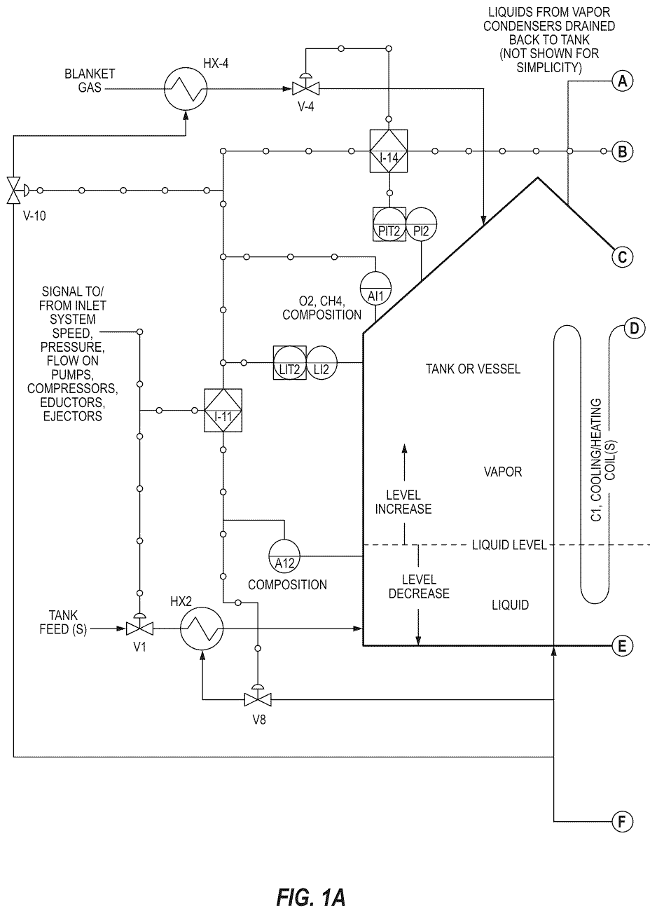

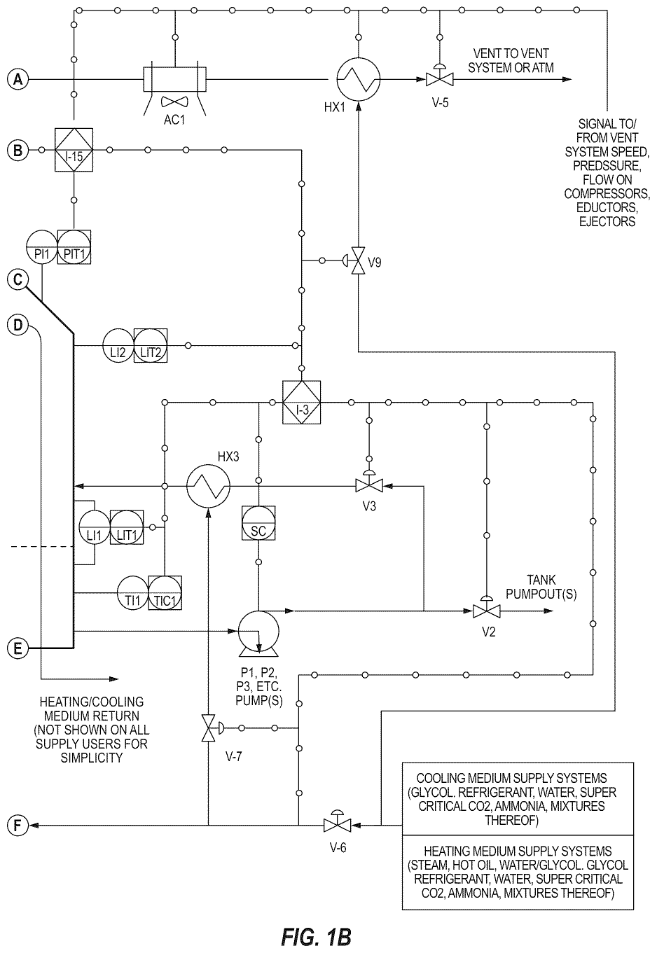

The system in FIG. 1 may be employed to monitor and change the volume of liquid(s) and/or vapor(s) within one or more tanks by changing fluid level, fluid(s) temperature, and/or fluid flow in and/or across tanks and equipment. FIG. 1 includes the following: pump(s) speed control SC; V2 pumpout valve; V3 pump recycle valve(v); V1 tank feed valve(s); V4 blanket gas valve(s); V5 tank vent valve(s); V6, V7, V8, V9 & V10 cooling medium valves; and coolers HX1, HX2, HX3, HX4, AC1 Cooling Coil(s) C1. Similarly, a heating medium system may be employed with equipment similar to the cooling equipment depicted to achieve pressure, temperature and level control. As shown in FIG. 1, cooling duties are adjusted to reduce emissions via PLC/DCS programming. The controller drops the level and/or pressure and/or temperature and/or changes the flows in or out of the tank or vessel to control level, temperature and pressure in the tank or vessel, thereby reducing or eliminating the vent or emissions. Similarly, heating duties are adjusted to prevent air ingress into the tank. The controller raises the level and/or pressure and/or temperature and/or changes the flows in or out of the tank or vessel to control level, temperature and pressure in the tank or vessel, thereby reducing or eliminating air ingress. System operating parameters adjustments may be made depending on tank gas analyzer(s) AI1 (O_{2,} CH₄, Composition) and/or liquid analyzer(s) AI2 (Composition),

To reduce or prevent emissions in FIG. 1, pump(s) P1, P2, P3, etc. speed control (SC) increases and/or V2 opens, and/or V4 closes, and/or V3 closes on a level rise on L1 or L2 and/or pressure rise on P1 and/or P2 and/or temperature rise on TI1 and/or TI2 in the tank or vessel. Similarly, to reduce or prevent emissions in FIG. 1, the cooling of the tank or vessel fluid or vapor entering, returning or leaving the tank or vessel can be accomplished with a tank or vessel liquid or vapor cooling coil(s) C1, vapor cooler(s) AC1 and/or HX1 and/or tank feed cooler HX2 and/or recycle cooler HX3 and/or blanket gas cooler HX4 which operate with a vapor or liquid cooling medium and are activated on a level rise on LI1 and/or LI2 and/or pressure rise on PI1 and/or PI2 and/or temperature rise on TI1 and/or TI2 in the tank or vessel. In this manner one may monitor and change the volume, and/or pressure and/or temperature of liquid(s) within the one or more tanks. System operating parameters adjustments may be made depending on tank gas analyzer(s) AI1 (O_{2,} CH₄, Composition) and/or liquid analyzer(s) AI2 (Composition),

According to present embodiments, stopping or reducing net liquid outflow from the tank cause the liquid level in the tank to increase, which in turn results in a corresponding increase in the tank pressure. This tank pressure increase reduces the amount of air that is pulled in through the PVRV's or reduces the amount of gas that must be provided by a blanket gas system. The level override is stopped when the tank pressure returns to the pre-rain range and the tank level reduced to the normal range by resuming liquid outlet(s) flow(s) and/or reducing liquid inlet(s) flow(s). The main invention component is a controller that connects the tank pressure indicator and transmitter to the tank liquid level indicator and controller. The new override controller sends a signal to the liquid level controller which causes the tank outlet level control valve to close and/or inlet level valve(s) to open, and/or the outlet(s) pump(s) to reduce speed or stop, and/or inlet(s) pump(s) to speed up or start, and/or the recycle flow to the tank to open stopping or reducing net liquid outflow from the tank. Similarly, tank fluid(s) temperatures or density (volume) and or pressure(s) may be increased to raise the tank pressure to prevent air ingress or tank pressure lowered to reduce vent emissions by increasing or decreasing temperatures of fluid(s) entering, exiting or recirculating to, from or within the tank boundary.

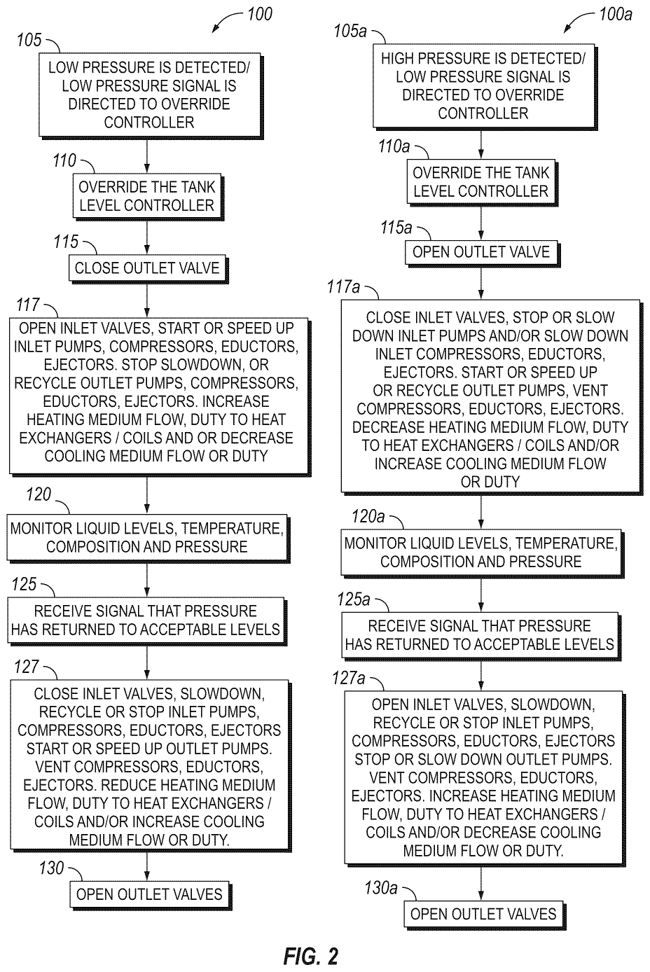

FIG. 2 illustrates a method flowchart illustrating a process according to an exemplary embodiment. As shown in FIG. 2, process 100 may be employed to monitor and change the volume of liquid(s) within the one or more tanks. Specifically, the process 100 describes how an override controller can override tank liquid level, and/or tank temperature level, and/or tank pressure level controls to equalize the pressure and change levels and/or temperatures of liquid(s) within one or more tanks by opening or closing inlet and outlet valves; start or speedup inlet pumps, compressors, eductors, and ejectors; stop slowdown or recycle outlet pumps, compressors, eductors, and ejectors and/or regulates heating and cooling to achieve similar objectives. On the other hand, the method also contemplates slowdown, recycle, or stop inlet pumps, compressors, eductors, and ejectors; start or speed up outlet pumps, compressors, eductors, and ejectors and/or regulates heating and cooling to achieve similar objectives. System operating parameters adjustments may be made depending on tank gas analyzer(s) (O_{2,} CH₄, Composition) and/or liquid analyzer(s) (Composition),

The methods of processes 100 can be associated without limitation for storing and transporting liquids such as water, petroleum, chemicals, or any liquids in the known art. Although the process 100 describes a method with reference to only one tank and other singular elements, it is understood that multiple tanks and multiple elements-e.g. multiple override controllers, tank gas analyzers (O_{2,} CH₄, Composition) and/or liquid analyzer(s) (Composition), tank liquid level controllers, pump(s) motor and speed controllers, tank temperature controllers, and tank pressure level controllers-are contemplated. The process 100 can begin with action 105, in which the override controller receives a signal from any combination of the tank liquid level controller, the tank liquid level reader, the tank pressure level controller, the tank pressure level reader, the tank temperature level controller, and/or the tank temperature reader. The signal can be received over a wired or wireless connection. The signal can include without limitation a message indicating that the pressure is too low, too high or otherwise imbalance, and/or that the tank liquid level is too low or otherwise imbalanced, and/or that the tank temperature is too low or otherwise imbalanced. These messages can be generated by any of the tank liquid level controller, the tank liquid level reader, the tank pressure level controller, the tank pressure level reader and/or the tank temperature controller, and the tank temperature reader in response to a change in liquid level, liquid temperature(s) and/or pressure level. System operating parameters adjustments may also be made depending on tank gas analyzer(s) AI1 (O_{2,} CH₄, Composition) and/or liquid analyzer(s) AI2 (Composition), In action 110, the override controller can, upon receiving the signal from action 105, override the tank liquid level controller or tank temperature controller. Similarly, a logic control Process 100 may be based on high pressure detected in the tank and is illustrated written as Process 100a, with logic for reducing pressure not increasing-opposite Process 100.

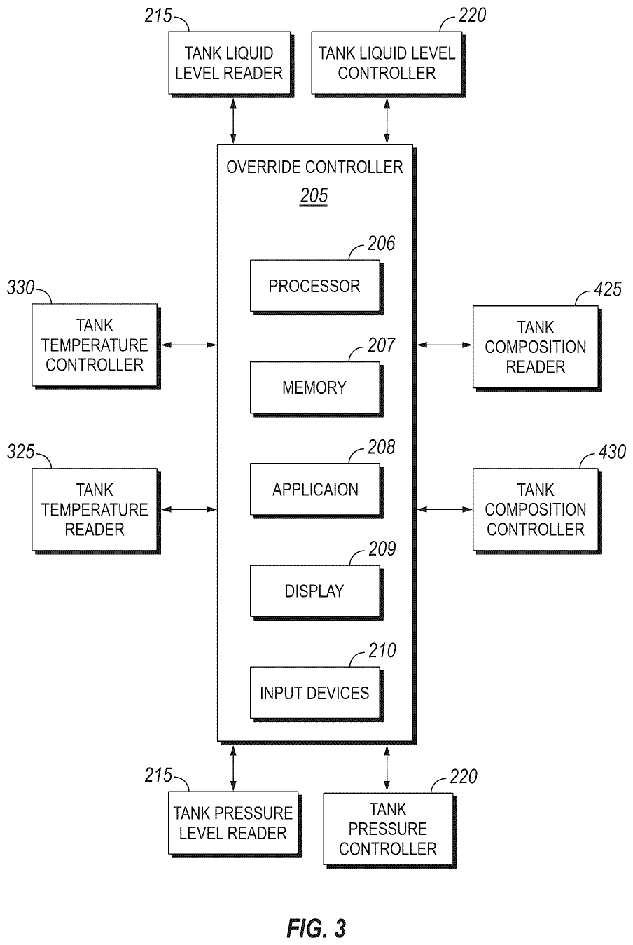

The tank liquid level controller, discussed with further reference to FIG. 3, can control the liquid level and/or temperature of the tank or multiple tanks using, for example, the process steps described above for process 100 of FIG. 2. The tank liquid level controller 220 in FIG. 3 and/or tank temperature controller 330, and/or composition controller 430 can control the liquid level of the tank by adjusting the inlets and outlets of the tank and inlet and outlet pump operation (start/stop/speed), as well as implementing the other steps 105, 110, 115, 117, 120, 125, 127, and/or 130 in FIG. 2. Process 100a with steps 105a, 110a, 115a, 117a, 120a, 125a, 127a and/or 130a in FIG. 2 has similar but opposite functionality of Process 100 also in FIG. 2. Process 100a also utilizes the same controllers as Process 100 in FIG. 3.

For example, the tank may have one liquid inlet and one liquid outlet. The tank liquid level controller can open the liquid outlet to let more liquid out of the tank, thus lowering the liquid level of the tank. Each outlet and inlet can be completely closed or completely opened. In other embodiments, each outlet and inlet can be partially closed or partially opened. The tank liquid level controller can adjust each outlet or inlet, as well as controlling inlet and outlet pumps, compressors, eductors, and ejectors to start, speed, slow, or stop liquid(s) flow, through a wired or wireless connection. The tank liquid level controller can perform these adjustments through one or more processors. Similarly, the tank temperature controller can perform actions by opening or closing heating or cooling medium system valves and modulating heating or cooling heat exchangers to adjust the system level, temperature and/or pressure in combination with the liquid flows. System operating parameters adjustments may be made depending on tank gas analyzer(s) (O_{2,} CH₄, Composition) and/or liquid analyzer(s) (Composition),

In other embodiments, the override controller can instead override the tank pressure level controller, tank temperature controller, and/or any combination of the tank level liquid controller, tank temperature controller and/or the tank pressure level controller. The tank pressure level controller, discussed with further reference to FIG. 3, can control the pressure within the container via one or more pressure and/or flow inlets and pressure and/or flow outlets, as well as by controlling inlet and outlet pumps, compressors, eductors, and ejectors. The pressure and/or flow inlets and pressure and/or flow outlets can include some or all of the same liquid outlets and liquid inlets controlled also by the tank liquid level controller. For example, the tank pressure level controller can control a pressure inlet configured to let in more gas to equalize or otherwise adjust the pressure within the container. In another example, the tank pressure level controller can adjust the amount of tank liquid inflow or tank liquid outflow to increase or decrease the pressure and level respectively. In another example the tank pressure level controller can adjust the speed or operation of pumps, compressors, eductors, and/or ejectors to increase or decrease the pressure and level. In another example, the tank pressure level controller can adjust the pressure inlet such that the amount of gas let into the container is reduced or increased as needed. It is understood that the override controller can control both the tank liquid level controller, tank temperature controller, and/or the tank liquid pressure controller in separate actions or the same actions in response to receiving a signal that the pressure within the container is imbalanced or otherwise undesirable. For example, in action 115, the override controller can close one or more outlet valves, open one or more inlet valve, slow down and/or stop liquid outlet pumps and/or start or speed up liquid inlet pumps. The outlet and inlet valves can be liquid inlet/outlet valves or gas inlet/outlet valves. In other embodiments, the override controller can close one or more outlet valves and/or open one or more inlet valves, e.g. one or more liquid inlet and/or valves or gas inlet/outlet valves. It is understood that the override controller can close both inlet and outlet valves independently or at the same time. It is also understood that the override controller may directly control the outlets and inlets. Similar actions can be taken to control the system temperatures by adjusting the temperatures of any of the fluids entering, recirculating or within the system boundary by adjusting heating or cooling flows or duties. System operating parameters adjustments may be made depending on tank gas analyzer(s) (O_{2,} CH₄, Composition) and/or liquid analyzer(s) (Composition),

In other embodiments, the override controller can control the outlets and inlets through either or both the tank liquid level controller, tank temperature controller and/or the tank pressure level controller. The override controller can control the outlets, inlets, pumps, compressors, eductors, ejectors, valves, tank liquid level controller, tank temperature controller and/or tank pressure level controller through a wired or wireless connection. In this manner the fluid level and/or fluid flow (including vapor space) in, out, and/or across tanks and equipment may be controlled. It also understood that the override controller can perform multiple adjustments to the outlets and inlets in response to one or more signals. Upon adjusting the outlets and inlets, the override controller in action 120 can monitor the liquid levels, temperature levels and pressure levels via the tank liquid level reader, tank temperature reader and/or the tank pressure level reader. The action of monitoring can refer to the override controller receiving one or more signals from either or both the tank liquid level reader, the tank temperature level reader, and/or the tank pressure level reader. Assuming that the pressure or liquid level within that tank has changed in response to action 115, the override controller in action 125 can receive one or more signals that the pressure in the tank and/or temperature in the tank has reached an acceptable level. In other embodiments, the override controller can receive a signals that either or both the pressure, temperature and/or liquid level has reached an acceptable level. The acceptable level can be a predetermined level of pressure, temperature or liquid level. The override controller can receive the one or more signals from either or both the tank liquid level reader, tank temperature level reader, and/or the tank pressure level reader. These one or more signals can be received over a wired or wireless network. Having received one or more signals that the pressure, and/or temperature and/or the liquid levels within the tank have reached acceptable levels, the override controller in action 130 can open or close one or more outlets and inlets including liquid outlets, liquid inlets, gas outlets, and gas inlets and start or stop pumps, compressors, eductors, ejectors or other liquid or vapor moving equipment to control level and/or pressure. Similar actions can be taken to control the system temperatures by adjusting the temperatures of any of the fluids entering, recirculating or within the system boundary by adjusting heating or cooling flows or duties. System operating parameters adjustments may be made depending on tank gas analyzer(s) (O_{2,} CH₄, Composition) and/or liquid analyzer(s) (Composition),

FIG. 3 is a block diagram illustrating a system 200. The system 200 can include without limitation an override controller 205, a tank liquid level reader 210, a tank liquid level controller 215, a tank pressure level reader 220, and a tank pressure controller 225 and/or a tank temperature reader 325 and/or a tank temperature controller 330 and or tank composition reader 425 and tank composition controller 430. In this manner one or more up to all of the steps shown in FIG. 2 may be undertaken by the system of FIG. 3 to control the fluid level and/or fluid flow (including vapor space) in, out, and/or across tanks and equipment may be controlled.

The override controller 205 may include a processor 206, a memory 207, and an application 208. The processor 206 may be a processor, a microprocessor, or other processor, and the override controllers 205 may include one or more of these processors. The processor 206 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 206 may be coupled to the memory 207. The memory 207 may be a read-only memory, write-once read-multiple memory or read/write memory, e.g., RAM, ROM, and EEPROM, and the override controllers 205 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 207 may be configured to store one or more software applications, such as the application 208, and other data, such as user's private data and financial account information.

The application 208 may comprise one or more software applications, such as a mobile application and a web browser, comprising instructions for execution on the override controller 205. In some examples, the override controller 205 may execute one or more applications, such as software applications, that enable, for example, network communications with one or more components of the system 205, transmit and/or receive data, and perform the functions described herein. Upon execution by the processor 206, the application 208 may provide the functions described in this specification, specifically to execute and perform the steps and functions in the process flows described below. Such processes may be implemented in software, such as software modules, for execution by computers or other machines. The application 208 may provide graphical user interfaces (GUIs) through which a user may view and interact with other components and devices within the system 205. The GUIs may be formatted, for example, as web pages in HyperText Markup Language (HTML), Extensible Markup Language (XML) or in any other suitable form for presentation on a display device depending upon applications used by users to interact with the system 200.

The override controller 205 may further include a display 209 and input devices 210. The display 209 may be any type of device for presenting visual information such as a computer monitor, a flat panel display, and a mobile device screen, including liquid crystal displays, light-emitting diode displays, plasma panels, and cathode ray tube displays. The input devices 210 may include any device for entering information into the override controller 205 that is available and supported by the override controller 205, such as a touch-screen, keyboard, mouse, cursor-control device, touch-screen, microphone, digital camera, video recorder or camcorder. These devices may be used to enter information and interact with the software and other devices described herein.

The system also includes a tank liquid level reader 215 which can be configured with a processor capable of measuring or reader the liquid level within one or more tanks. The tank level liquid controller 220 can include a processor configured to open, close, or partially open one or more outlets and inlets into the one or more tanks and/or configured to start, stop, speed up or slow down or recycle one or more outlet or inlet pumps, compressors, ejectors, eductors or other motive force fluid processing equipment.. The tank pressure level reader 225 can measure or read, by a processor, the pressure level within the tank. The tank pressure controller 230 includes, without limitation, a processor configured to open close, or partially open one or more gas outlets and gas inlets and/or configured to start, stop, speed up or slow down or recycle one or more outlet or inlet pumps, compressors, ejectors, eductors or other motive force fluid processing equipment. for the purpose of equalizing or otherwise adjusting the pressure and/or level within the tank. The tank temperature reader 325 can measure or ready, by a processor, tank temperature level within the tank. The tank temperature controller 330 includes, without limitation, a processor configured to open close, or partially open or close one or more heating or cooling medium flow valves, partially open one or more gas outlets and gas inlets and/or configured to start, stop, speed up or slow down or recycle one or more outlet or inlet pumps, compressors, ejectors, eductors or other motive force fluid processing equipment. for the purpose of equalizing or otherwise adjusting the pressure and/or level within the tank. System operating parameters adjustments may also be made depending on tank gas analyzer(s) (O_{2,} CH₄, Composition) and/or liquid analyzer(s) (Composition) via analyzer composition reader 425 and analyzer composition controller 430.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

In some aspects, the techniques described herein relate to a system for monitoring and influencing the liquid level, liquid temperature and/or pressure level within a tank, the system including: a tank liquid level reader; a tank liquid level controller; a tank temperature reader; a tank temperature level controller; a tank pressure level reader; a tank pressure controller; a tank composition reader; a tank composition controller; an override controller, wherein the override controller is configured to: receive a signal from the pressure reader, the signal including at least a reading that the pressure within the tank has reached a predetermined level; transmit to the tank level controller and/or temperature controller a command to reduce or stop the flow of liquid out of the tank via the liquid outlet; transmit to the tank level controller a command to increase or start the flow of liquid into the tank; monitor tank levels; receive a second signal from the pressure reader, the second signal including at least a reading that the pressure within the tank has reached a safe level; transmit to the tank level controller a command to increase or resume the flow of liquid out of the tank via the liquid outlet(s) and/or reduce or recycle or stop the flow of liquid into the tank via the liquid inlet(s). Similarly, commands to increase or decrease the tank fluids temperature by modulating heating or cooling medium flow or heat exchange duties may be completed in combination with the described flow and level control. System operating parameters adjustments may also be made depending on tank gas analyzer(s) (O_{2,} CH₄, Composition) and/or liquid analyzer(s) (Composition).

In some aspects, the techniques described herein relate to a method for monitoring and controlling the internal pressure level within a tank, the method including the steps of: receiving, by an override controller, a signal from a pressure reader, the signal including at least a reading that the pressure within the tank has reached a predetermined pressure; transmitting, by the override controller, a command to reduce or stop the flow of liquid out of the tank via the liquid outlet(s); and/or reduce or recycle or stop the flow of liquid into the tank via the liquid inlet(s); monitor tank levels; receive a second signal from the pressure reader, the second signal including at least a reading that the pressure within the tank has reached a safe level; transmit to the tank level controller a command to increase or resume the flow of liquid of the tank via the liquid outlet(s) and/or reduce or recycle or stop the flow of liquid into the tank via the liquid inlet(s). Similarly, commands to increase or decrease the tank fluids temperature by modulating heating or cooling medium flow or heat exchange duties may be completed in combination with the described flow and level control. System operating parameters adjustments may also be made depending on tank gas analyzer(s) (O_{2,} CH₄, Composition) and/or liquid analyzer(s) (Composition).

In some aspects, the techniques described herein relate to an apparatus including an override controller configured to: receive one or more signals from a liquid level reader, liquid temperature level and/or pressure reader associated with an enclosed tank; transmit one or more commands to a liquid level controller, temperature controller and/or pressure controller to reduce or stop liquid outlet; monitor tank levels; receive a second signal from the pressure reader, the second signal including at least a reading that the pressure within the tank has reached a safe level; transmit to the tank level controller a command to increase or resume the flow of liquid of the tank via the liquid outlet(s) or decrease or cease the flow of liquid into the tank via the liquid inlet(s). Similarly, commands to increase or decrease the tank fluids temperature by modulating heating or cooling medium flow or heat exchange duties may be completed in combination with the described flow and level control. System operating parameters adjustments may also be made depending on tank gas analyzer(s) (O_{2,} CH₄, Composition) and/or liquid analyzer(s) (Composition).

### Specific Embodiments

The vapor management systems and methods described herein are unique in coordinating and controlling both vapor emissions and flammable atmosphere on a system wide approach. Specifically, the vapor management system involves one or both of the following functions: 1) Emissions control of hydrocarbons, methane, CO2, nitrogen, greenhouse gases, toxic or chemical vapors; and/or 2) System flammable atmosphere prevention-Air (Oxygen) Ingress control & prevention.

The vapor management system may comprise the following: 1) System Components (vessels, tanks, pipes, processes, and associated process equipment; 2) Instrumentation; and/or 3) Controls (control logic, signals, calculations, control system and end devices).

The vapor management system may be designed, coordinated, and controlled to achieve the objective functions 1) and 2) above through the management, coordination, control and/or manipulation of the following system process parameters and variables:
A) Pressure (sensed with pressure indicators/transmitters and one may increase or decrease system pressure by one or more of the following:

System Valve modulation: Changing speed or power modulation of rotating equipment (pumps, compressors, turbines); Changing system temperature, level or composition control via flow control; Adding or removing system mass (vapor or liquid); Changing system temperature; Changing system level or volume; and/or Changing system inflow or outflow (flow rates).

Changing Flow (sensed with flow meter/flow sensor directly or indirectly by other parameters). One may increase or decrease system flow (of mass, volume, energy) by one or more of the following: Changing speed or power modulation of rotating or fixed equipment (pumps, compressors, turbines, heat exchangers; Changing temperature/pressure/level or composition control via flow or power control; System valve modulation; and/or Changing system pressure to control flow.

Changing Temperature (sensed with temperature indicator, sensors/transmitters). One may Increase or decrease system temperature by one or more of the following: Changing system cooling or heating medium flow; Changing system heat transfer equipment Air, water, liquid, gas or supercritical fluid flow; Changing the system fluid mixing flow or ratio; Changing the system mass or volume; Changing the system recycle rates and recycle fluid temperature; and/or Changing the system composition by adding, removing or reacting system volume or components.

Changing Level (sensed with level indicators and transmitters internal or external to the system). One may increase or decrease system level by one or more the following: System Valve modulation; Changing speed or power modulation of rotating equipment (pumps, compressors, turbines); Changing system temperature, level or composition control via flow control; Changing the system liquid, vapor or solid mass or volume flow in, out or through the system; Changing the system temperature; Changing the system pressure; and/or Changing the system composition.

Changing Composition (measured by analyzers or predicted by simulation or calculation). One may measure system components (liquid, vapor, solid), concentration or volume, mol fraction, mol %, ppmv ppmw including but not limited to oxygen, CO₂, hydrocarbons, methane, inerts, toxic gases or other compounds or chemical. One may calculate system components (liquid, vapor, solid), concentration or volume, mol fraction, mol %, ppmv ppmw including but not limited to oxygen, CO₂, hydrocarbons, methane, inerts, toxic gases or other compounds or chemicals. One may change system composition by one or more of the following: Changing system temperature; Changing system pressure; Changing system flow, reaction, recycle or flow in or out of system; Changing system level; System valve modulation; and/or Changing speed or power modulation of rotating equipment (pumps, compressors, turbines).

### ADDITIONAL DESCRIPTION

The following clauses are intended to be a further description of examples of embodiments of the invention. These embodiments may be used in any appropriate combination.
1. A system for monitoring and influencing the liquid level and pressure level within a tank, the system comprising a means for changing fluid level, fluid flow, or both, in or across tanks and equipment.
2. The system of clause 1 wherein the means for changing fluid level, fluid flow, or both comprises: a tank liquid level reader; a tank liquid level controller; a tank pressure level reader; a tank pressure controller; an override controller, wherein the override controller is configured to: receive a signal from the pressure reader, the signal comprising at least a reading that the pressure within the tank has reached a predetermined level; transmit to the tank level controller a command to reduce or stop the flow of liquid out of the tank via the liquid outlet(s); transmit to the tank level controller a command to increase or start the flow of liquid into the tank via the liquid inlet(s); transmit to the inlet and outlet pump, compressor, ejector or eductor power or speed control a command to start, stop, speed up or slow down or recycle the aforementioned fluid moving equipment and/or open or close associated valves to complete similar control action; monitor tank levels; receive a second signal from the pressure reader, the second signal comprising at least a reading that the pressure within the tank has reached a safe level; transmit to the tank level controller a command to increase or resume the flow of liquid of the tank via the liquid outlet(s); transmit to the tank level controller a command to decrease or cease the flow of liquid into the tank via the liquid outlet(s); transmit to the tank level controller a command to start, stop, speed up or slow down or recycle the pump(s), compressor(s), eductor(s), ejector(s) or similar fluid moving equipment and/or open or close associated valves to complete similar control action.
3. A method for monitoring and controlling the internal pressure level within a tank wherein the method comprises changing fluid level, fluid flow, or both, in or across tanks and equipment.
4. The method of clause 3 wherein the changing fluid level, fluid flow or both comprises the steps of: receiving, by an override controller, a signal from a pressure reader, the signal comprising at least a reading that the pressure within the tank has reached a predetermined pressure; transmitting, by the override controller, a command to reduce or stop the flow of liquid out of the tank via the liquid outlet(s); transmitting, by the override controller, a command to speed up or start the flow of liquid into the tank via the liquid inlet(s); transmitting, by the override controller, a command to start or speed up the inlet pump(s), compressor(s), ejector(s) or eductor(s) power or speed control and/or open or close associated valves to complete similar control action; monitor tank levels; receive a second signal from the pressure reader, the second signal comprising at least a reading that the pressure within the tank has reached a safe level; transmit to the tank level controller a command to increase or resume the flow of liquid of the tank via the liquid outlet(s); transmit to the tank level controller a command to decrease or cease the flow of the liquid into the tank via the liquid inlet(s); transmit to the tank level controller a command to stop or slow down or recycle the inlet pump(s), compressor(s), ejector(s) or eductor(s) power or speed control and/or open or close associated valves to complete similar control action.
5. A system comprising: an override controller configured to: receive one or more signals from a liquid level reader or pressure reader associated with an enclosed tank; transmit one or more commands to a liquid level controller and pressure controller to reduce or stop liquid outlet(s); transmit one or more commands to a liquid level controller and pressure controller to increase or start liquid inlet(s); transmit one or more commands to a liquid level controller and pressure controller to a command to start or speed up the inlet pump(s), compressor(s), ejector(s) or eductor(s) power or speed control and/or open or close associated valves to complete similar control action; monitor tank levels; receive a second signal from the pressure reader, the second signal comprising at least a reading that the pressure within the tank has reached a safe level; transmit to the tank level controller a command to increase or resume the flow of liquid of the tank via the liquid outlet(s); transmit to the tank level controller a command to decrease or cease the flow of liquid into the tank via liquid inlet(s); and transmit the tank level controller a command to stop or slow down or recycle the inlet pump(s), compressor(s), ejector(s) or eductor(s) power or speed control and/or open or close associated valves to complete similar control action.
6. A system for monitoring and influencing the liquid level, temperature level and pressure level within a tank, the system comprising a means for changing one or more of fluid level, fluid temperature, fluid composition, fluid pressure, and fluid flow in and/or across tanks and equipment.
7. The system of clause 6 wherein the means for changing one or more of fluid level, fluid temperature, fluid composition, fluid pressure, and fluid flow comprises: a tank liquid level reader; a tank liquid level controller; a tank pressure level reader; a tank pressure controller; a tank temperature reader; a tank temperature controller; a tank composition analyzer; a tank composition controller an override controller, wherein the override controller is configured to: receive a signal from the pressure reader, the signal comprising at least a reading that the pressure within the tank has reached a predetermined level; transmit to the tank level controller a command to reduce or stop the flow of liquid out of the tank via the liquid outlet(s); transmit to the tank level controller a command to increase or start the flow of liquid into the tank via the liquid inlet(s); transmit to the inlet and outlet pump, compressor, ejector or eductor power or speed control a command to start, stop, speed up or slow down or recycle the aforementioned fluid moving equipment and/or open or close associated valves to complete similar control action; monitor tank levels; receive a second signal from the pressure reader, the second signal comprising at least a reading that the pressure within the tank has reached a safe level; transmit to the tank level controller a command to increase or resume the flow of liquid of the tank via the liquid outlet(s); transmit to the tank level controller a command to decrease or cease the flow of liquid into the tank via the liquid outlet(s); transmit to the tank level controller a command to start, stop, speed up or slow down or recycle the pump(s), compressor(s), eductor(s), ejector(s) or similar fluid moving equipment and/or open or close associated valves to complete similar control action; receive a third signal from the temperature reader, the third signal comprising at least a reading that the temperature in the tank has reached an acceptable value; transmit to the tank and system temperature controllers a command to increase or decrease heating or cooling medium flow valves or equipment to raise or lower the fluid temperatures by complete similar control action in coordination with the pressure, level and composition controller; receive a fourth signal from the composition reader (analyzer), the third signal comprising at least a reading that the composition in the tank has reached an acceptable value; transmit to the tank level, pressure, flow controllers a command to adjust the tank and system composition by increasing or decreasing system flows, equipment speeds in coordination with the pressure, level and temperature controllers and override controllers.
8. A method for monitoring and controlling the internal pressure level within a tank wherein the method comprises changing one or more of fluid level, fluid temperature, fluid composition and fluid flow in and/or across tanks and equipment.
9. The method of clause 8 wherein the changing one or more of fluid level, fluid temperature, fluid composition and fluid flow comprises: receiving, by an override controller, a signal from a pressure reader, the signal comprising at least a reading that the pressure within the tank has reached a predetermined pressure; transmitting, by the override controller, a command to reduce or stop the flow of liquid out of the tank via the liquid outlet(s); transmitting, by the override controller, a command to speed up or start the flow of liquid into the tank via the liquid inlet(s); transmitting, by the override controller, a command to start or speed up the inlet pump(s), compressor(s), ejector(s) or eductor(s) power or speed control and/or open or close associated valves to complete similar control action; receiving, by an override controller, a signal from a temperature reader, the signal comprising at least a reading that the temperature in the tank has reached an acceptable value; transmitting, by the override controller, a command to adjust the tank and system fluid(s) temperature(s) by increasing or decreasing heating or cooling medium flow valves or equipment in coordination with the pressure, level and composition controllers and override controllers; receiving, by an override controller, a signal from a composition reader (analyzer), the signal comprising at least a reading that the composition in the tank has reached an acceptable value; transmitting, by the override controller, a command to adjust the tank and system composition by increasing or decreasing system flows, equipment speeds in coordination with the pressure, level and temperature controllers and override controllers; monitor tank levels; receive a second signal from the pressure reader, the second signal comprising at least a reading that the pressure within the tank has reached a safe level; transmit to the tank level controller a command to increase or resume the flow of liquid of the tank via the liquid outlet(s); transmit to the tank level controller a command to decrease or cease the flow of the liquid into the tank via the liquid inlet(s); transmit to the tank level controller a command to stop or slow down or recycle the inlet pump(s), compressor(s), ejector(s) or eductor(s) power or speed control and/or open or close associated valves to complete similar control action.
10. An apparatus comprising: an override controller configured to: receive one or more signals from a liquid level reader, temperature reader, composition reader and/or pressure reader associated with an enclosed tank; transmit one or more commands to a liquid level controller, temperature controller, composition controller and/or pressure controller to reduce or stop liquid outlet(s); transmit one or more commands to a liquid level controller, temperature controller, composition controller and/or pressure controller to increase or start liquid inlet(s); transmit one or more commands to a liquid level controller, temperature controller, composition controller and/or pressure controller to a command to start or speed up the inlet pump(s), compressor(s), ejector(s) or eductor(s) power or speed control and/or open or close associated valves to complete similar control action; monitor tank levels; receive a second signal from the pressure reader, the second signal comprising at least a reading that the pressure within the tank has reached a safe level; transmit to the tank level controller a command to increase or resume the flow of liquid of the tank via the liquid outlet(s); transmit to the tank level controller a command to decrease or cease the flow of liquid into the tank via liquid inlet(s); and transmit the tank level controller a command to stop or slow down or recycle the inlet pump(s), compressor(s), ejector(s) or eductor(s) power or speed control and/or open or close associated valves to complete similar control action; receive a signal from the temperature reader, the third signal comprising at least a reading that the temperature in the tank has reached an acceptable value; transmit to the tank and system temperature controllers a command to increase or decrease heating or cooling medium flow valves or equipment to raise or lower the fluid temperatures by complete similar control action in coordination with the pressure, level and composition controllers; receive a signal from the composition reader (analyzer), the signal comprising at least a reading that the composition in the tank has reached an acceptable value; transmit to the tank level, pressure, flow controllers a command to adjust the tank and system composition by increasing or decreasing system flows, equipment speeds in coordination with the pressure, level and temperature controllers and override controllers.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper,” “lower,” “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

What is claimed is:

1. A system for monitoring and influencing the liquid level and pressure level within a tank, the system comprising a means for changing fluid level, fluid flow, or both, in or across tanks and equipment.

2. The system of claim 1 wherein the means for changing fluid level, fluid flow, or both comprises:
a tank liquid level reader;
a tank liquid level controller;
a tank pressure level reader;
a tank pressure controller;
an override controller, wherein the override controller is configured to:
receive a signal from the pressure reader, the signal comprising at least a reading that the pressure within the tank has reached a predetermined level;
transmit to the tank level controller a command to reduce or stop the flow of liquid out of the tank via the liquid outlet(s);
transmit to the tank level controller a command to increase or start the flow of liquid into the tank via the liquid inlet(s);
transmit to the inlet and outlet pump, compressor, ejector or eductor power or speed control a command to start, stop, speed up or slow down or recycle the aforementioned fluid moving equipment and/or open or close associated valves to complete similar control action;
monitor tank levels;
receive a second signal from the pressure reader, the second signal comprising at least a reading that the pressure within the tank has reached a safe level;
transmit to the tank level controller a command to increase or resume the flow of liquid of the tank via the liquid outlet(s);
transmit to the tank level controller a command to decrease or cease the flow of liquid into the tank via the liquid outlet(s);
transmit to the tank level controller a command to start, stop, speed up or slow down or recycle the pump(s), compressor(s), eductor(s), ejector(s) or similar fluid moving equipment and/or open or close associated valves to complete similar control action.

3. A method for monitoring and controlling the internal pressure level within a tank wherein the method comprises changing fluid level, fluid flow, or both, in or across tanks and equipment.

4. The method of claim 3 wherein the changing fluid level, fluid flow or both comprises the steps of:
receiving, by an override controller, a signal from a pressure reader, the signal comprising at least a reading that the pressure within the tank has reached a predetermined pressure;
transmitting, by the override controller, a command to reduce or stop the flow of liquid out of the tank via the liquid outlet(s);
transmitting, by the override controller, a command to speed up or start the flow of liquid into the tank via the liquid inlet(s);
transmitting, by the override controller, a command to start or speed up the inlet pump(s), compressor(s), ejector(s) or eductor(s) power or speed control and/or open or close associated valves to complete similar control action;
monitor tank levels;
receive a second signal from the pressure reader, the second signal comprising at least a reading that the pressure within the tank has reached a safe level;
transmit to the tank level controller a command to increase or resume the flow of liquid of the tank via the liquid outlet(s);
transmit to the tank level controller a command to decrease or cease the flow of the liquid into the tank via the liquid inlet(s);
transmit to the tank level controller a command to stop or slow down or recycle the inlet pump(s), compressor(s), ejector(s) or eductor(s) power or speed control and/or open or close associated valves to complete similar control action.

5. A system for monitoring and influencing the liquid level, temperature level and pressure level within a tank, the system comprising a means for changing one or more of fluid level, fluid temperature, fluid composition, fluid pressure, and fluid flow in and/or across tanks and equipment.

6. The system of claim 5 wherein the means for changing one or more of fluid level, fluid temperature, fluid composition, fluid pressure, and fluid flow comprises:
a tank liquid level reader;
a tank liquid level controller;
a tank pressure level reader;
a tank pressure controller;
a tank temperature reader;
a tank temperature controller;
a tank composition analyzer;
a tank composition controller. an override controller, wherein the override controller is configured to:
receive a signal from the pressure reader, the signal comprising at least a reading that the pressure within the tank has reached a predetermined level;
transmit to the tank level controller a command to reduce or stop the flow of liquid out of the tank via the liquid outlet(s);
transmit to the tank level controller a command to increase or start the flow of liquid into the tank via the liquid inlet(s);
transmit to the inlet and outlet pump, compressor, ejector or eductor power or speed control a command to start, stop, speed up or slow down or recycle the aforementioned fluid moving equipment and/or open or close associated valves to complete similar control action;
monitor tank levels;
receive a second signal from the pressure reader, the second signal comprising at least a reading that the pressure within the tank has reached a safe level;
transmit to the tank level controller a command to increase or resume the flow of liquid of the tank via the liquid outlet(s);
transmit to the tank level controller a command to decrease or cease the flow of liquid into the tank via the liquid outlet(s);
transmit to the tank level controller a command to start, stop, speed up or slow down or recycle the pump(s), compressor(s), eductor(s), ejector(s) or similar fluid moving equipment and/or open or close associated valves to complete similar control action;
receive a third signal from the temperature reader, the third signal comprising at least a reading that the temperature in the tank has reached an acceptable value;
transmit to the tank and system temperature controllers a command to increase or decrease heating or cooling medium flow valves or equipment to raise or lower the fluid temperatures by complete similar control action in coordination with the pressure, level and composition controllers;
receive a fourth signal from the composition reader (analyzer), the third signal comprising at least a reading that the composition in the tank has reached an acceptable value;
transmit to the tank level, pressure, flow controllers a command to adjust the tank and system composition by increasing or decreasing system flows, equipment speeds in coordination with the pressure, level and temperature controllers and override controllers.
